(19) United States
(12) Patent Application Publication
(10) Pub. No.: US 2005/0096099 A1
(43) Pub. Date: May 5, 2005

(54) Integrated hands free mobile system

(76) Inventors: Deborah Lewandowski Barclay, Winfield, IL (US); David S. Benco, Winfield, IL (US); Sanjeev Mahajan, Naperville, IL (US); Thomas Lee McRoberts, Naperville, IL (US); Raymond Leroy Ruggerio, Glenview, IL (US)

Correspondence Address: PATTI & BRILL, ONE NORTH LASALLE STREET, 44TH FLOOR, CHICAGO, IL, 60602, US

(21) Appl. No.: 10/701,334

(22) Filed: Nov. 4, 2003

(51) Int. Cl. H04M 1/00

(52) U.S. Cl. 455/569.2; 455/569.1

(57) ABSTRACT

The method and system is for providing hands free system for operating a mobile terminal in a vehicle. An embodiment of the system may have: a processing module detachably coupled to a mobile terminal; an audio input device mounted substantially in a center area of a steering wheel of the vehicle, the audio input device operatively connected to the processing module; a switch located in a predetermined area of the steering wheel, the switch operatively connected to the processing unit; and an audio output system operatively connected to the processing module. The method implements use of the system.

### TECHNICAL FIELD

The present invention relates to wireless telephony in general, and, more particularly, to embodiments of a method and system, which permit hands-free operation of a mobile telephone unit in a vehicle.

### BACKGROUND

The use of mobile terminals, such as cell phones, while driving automobiles has become quite prevalent. At the same time, statistics show that this kind of distracted driving can lead to accidents. The distraction may arise, for example, from one hand not being available for driving because it is holding a cell phone, or from a headset interfering with maneuverability of the driver, or from an earpiece preventing the driver from hearing surrounding traffic.

Mobile systems are known that are permanently installed in vehicles, such as automobiles. These permanently installed mobile systems do not allow the user to take them out when they leave the vehicle. This restricts accessibility to the subscriber when they are out of the vehicle. Additionally, these mobile systems, though better than hand held mobiles do require the driver to take their hands of the steering and eyes off the road to answer the call or dial a number.

If a microphone is installed at the roof of an automobile, reception is likely to be relatively poor since the microphone easily picks up noise and other interference. The quality of the sound picked up by the microphone is enhanced when the latter is installed on the driver's clothing. However, the range of movement of the driver is limited by the electrical cable, which connects the microphone to the main terminal unit. In addition, the electrical cable is always subjected to tension, thereby adversely affecting the service life of the cable.

Compared with the traditional telephone or the pager, the mobile phone (also referred to as a mobile terminal) is doubtless one of the favorite communication tools because of its portability and convenience. It is very common for a person to use a mobile phone when driving a car. However, since the use of a mobile phone when driving is considered to be unsafe, various kinds of hands-free devices have been developed for mobile phones to avoid this problem. Since interface sockets of mobile phones manufactured by different telephone venders are not the same, the hands-free device manufacturers have to produce different hands-free devices for use with different mobile phones, which may increase the cost of the hands-free device. Furthermore, users may have to purchase different hands-free devices to use with different mobile phones, which results in waste and inconvenience in the use of the hands-free devices.

Thus, there is a need in the prior art for the ability to connect any mobile handset to a built in adaptor in a vehicle or other apparatus. It is a drawback of the prior art that a mobile subscriber, for example, cannot place/receive calls, conduct conversations and terminate calls without holding any mobile terminals or attaching any headset or dialing any numbers from a keypad of the mobile terminal.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

In general terms one embodiment of the system is for providing a hands free system for operating a mobile terminal in a vehicle. This embodiment of the system may have: a processing module detachably coupled to a mobile terminal; an audio input device mounted substantially in a center area of a steering wheel of the vehicle, the audio input device operatively connected to the processing module; a switch located in a predetermined area of the steering wheel, the switch operatively connected to the processing unit; and an audio output system operatively connected to the processing module.

In general terms one embodiment of the method is for providing hands free operation of a mobile terminal in a vehicle. In this embodiment the method may have the steps of: (a) initially placing the system in an idle state; (b) determining if the switch has been toggled; (c) returning to step (a) if the switch has not been toggled, and muting the amplifier and turning on the microphone if the switch has been toggled; (d) collecting digits using voice recognition or determining the stored numbers to be dialed based on a voice token; (e) determining if the switch has been toggled; (f) returning to step (d) if the switch has not been toggled, and playing sounds for the numbers to be dialed via the amplifier and displaying the numbers on the display; (g) determining if the switch has been toggled; (h) starting, if the switch has not been toggled, a timer and when a predetermined time has expired returning to the idle state, and until then returning to step (g); (i) if the switch has been toggled, sending dialed numbers to the mobile terminal, connecting the earpiece output of the mobile terminal to the amplifier of the vehicle sound system, connecting the microphone to the microphone amplifier of the mobile terminal; (j) dialing the number at the mobile terminal; connecting the call; (k) maintaining call connection; determining if the switch has been toggled; returning to step (k) if the switch has not been toggled, and returning to step (a) if the switch has been toggled.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts one example of an embodiment of the present system.

FIGS. 2A and 2B depicts block diagrams illustrative of one embodiment of the present system.

FIG. 3 illustrates a very general flow chart of logical operational steps that may be followed in accordance with one embodiment of the present method.

FIG. 4 illustrates another flow chart of logical operational steps that may be followed in accordance with another embodiment of the present method.

### DETAILED DESCRIPTION

The particular values and configurations discussed in these non-limiting examples can be varied and are cited merely to illustrate an embodiment of the present invention and are not intended to limit the scope of the invention.

The present system and method embody various methodologies. For example, one methodology is to provide a built-in microphone and speaker system that may be used for making phone call. A further methodology is to provide a built-in switch that may be used to place and receive phone calls without using the mobile terminal keypad. This eliminates the possibility of the mobile terminal interfering with the operation of the vehicle. Another methodology is to provide a universal connector that may be used to connect any mobile terminal to the system. A further methodology is to provide a built-in method to specify the phone number to be dialed. Thus, using the built in adaptor in a vehicle or other apparatus, any mobile handset may be connected. The mobile subscriber, for example, may place/receive calls, conduct conversations and terminate calls without the need to hold the mobile terminals or attach any headset or dial any numbers from a keypad of the mobile terminal.

Other methodologies are as follows. The mobile terminal manufacturer is provided with a method to connect the mobile terminal to the integrated hands free mobile system module in the vehicle. The automotive stereo manufacture is provided with a method to connect to the integrated hands free mobile system and gives precedence to the signal from the mobile terminal when a call is placed and received. Also, include is a methodology for connecting the integrated hands free mobile system to a personal computer (PC).

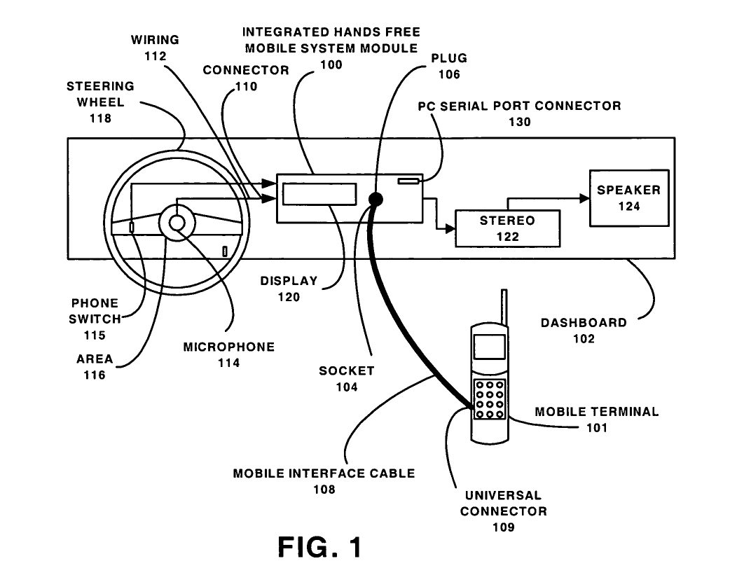

In one embodiment, as schematically depicted in FIG. 1, the integrated hands free mobile system module 100 is mounted in the dashboard 102 of a vehicle and may be operatively connected to a mobile terminal 101. The integrated hands free mobile system 100 has a socket 104 for receiving a plug 106 on a mobile interface cable 108. The mobile interface cable 108 may also have a universal connector 109 for connecting to the mobile terminal 101. The integrated hands free mobile system 100 also has a connector 110 for connecting to the wiring 112 from a microphone 114 that is mounted in a center area 116 of a steering wheel 118. The steering wheel 118 has also mounted thereon at least one phone switch 115, which is operatively connected to the integrated hands free mobile system module 100. The phone switch 115 may a toggle-type switch, and each toggle of the switch is an indication to proceed to the next stage in call handling.

The integrated hands free mobile system module 100 may also have a display 120, which may display information, such as, phone numbers with corresponding names and addresses, information downloaded from the mobile terminal, etc. The integrated hands free mobile system module 100 may also be connected to vehicle sound system, such as stereo 122. The audio from the mobile terminal 101 may be reproduced through a speaker 124 that is connected to the stereo 122. The integrated hands free mobile system module 100 may also have a PC serial port connector 130.

The universal connector 109 for mobile interface cable 108 may be an interface for one or more of the following elements, and in one embodiment the connector 109 is an interface for all of the following elements. As one interface the connector 109 functions to interface an audio input source to an external audio source. An audio stream coming on this interface may be processed like audio from an internal microphone. As another interface the connector 109 functions to interface an audio output to an external stereo. As a further interface the connector 109 functions as an interface that accepts digits to be dialed along with a signaling protocol to specify a number string as a phone number to be dialed. As yet another interface the connector 109 functions as an interface that provides calling party details to an external device along with a signaling protocol to specify the text/ number string as calling party details. As another interface the connector 109 functions as an interface that takes a call through various call states based on a signaling protocol, that is an interface that picks up an incoming call, toggle between calls, hangs up etc.

The mobile terminal 101 may therefore implements the interface and protocol (universal connector 109) with a processing module. In addition the integrated hands free mobile system module 100 may have functionality to implement a signaling protocol for the universal connector 109. The integrated hands free mobile system module 100 may further have an ability to display calling party details on the display 120 and an ability to voice synthesize calling party details and play the voice synthesized calling party details on the stereo 122.

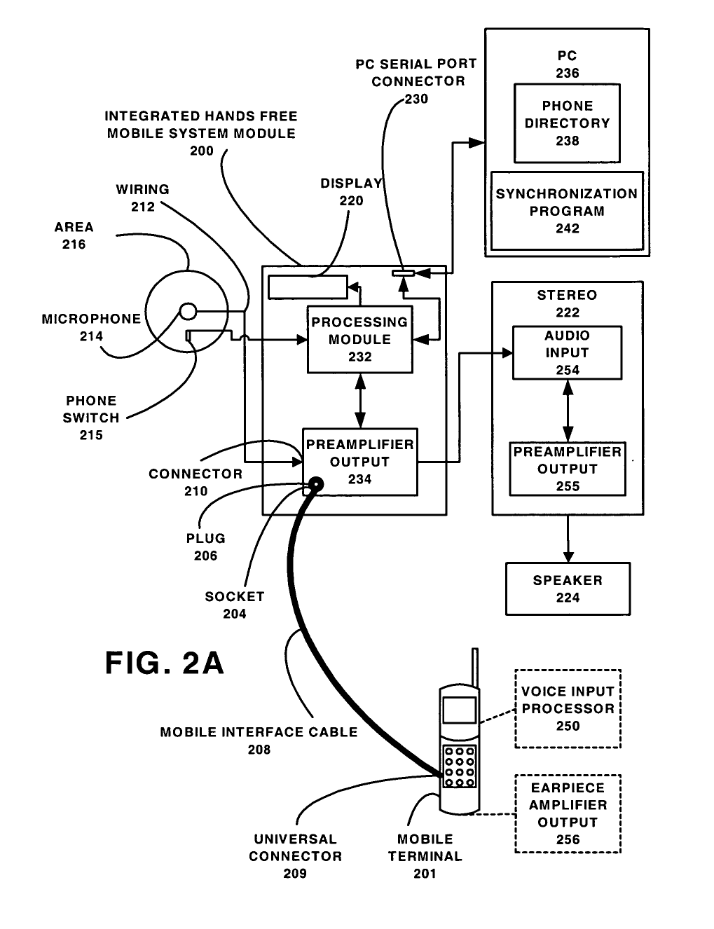

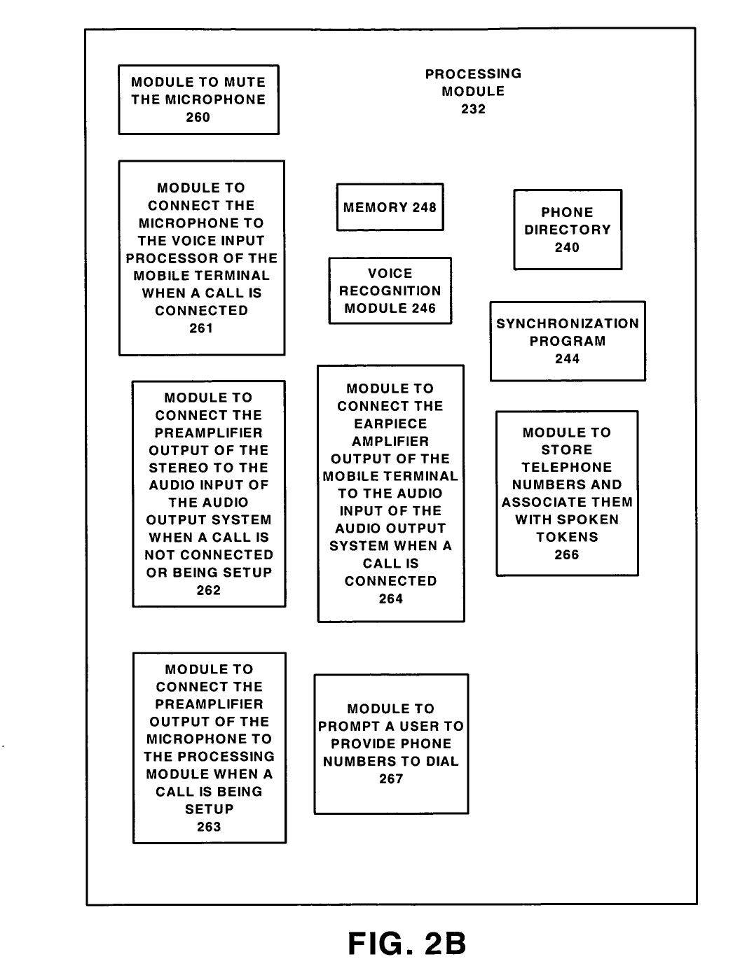

One embodiment of the present system and method is depicted in FIGS. 2A and 2B. As depicted in FIG. 2A, the integrated hands free mobile system module 200 may have a processing module 232 and a preamplifier 234. The preamplifier 234 amplifies the microphone input to a signal level appropriate for a voice recognition and input to the amplifier. The processing module 232 and the preamplifier 234 are operatively connected.

As similarly described in FIG. 1, the integrated hands free mobile system module 200 may be operatively connected to a mobile terminal 201. The integrated hands free mobile system 200 has a socket 204 for receiving a plug 206 on a mobile interface cable 208. The mobile interface cable 208 may also have a universal connector 209 for connecting to the mobile terminal 201. The integrated hands free mobile system 200 also has a connector 210 for connecting to the wiring 212 from a microphone 214 that is mounted in an area 216. At least one phone switch 215 is operatively connected to the integrated hands free mobile system module 200. The phone switch 215 may a toggle-type switch, and each toggle of the switch may be an indication to proceed to the next stage in call handling.

The integrated hands free mobile system module 200 may also have a display 220, which may display information, such as, phone numbers with corresponding names and addresses, information downloaded from the mobile terminal, etc. The integrated hands free mobile system module 200 may also be connected to vehicle sound system, such as stereo 222. The audio from the mobile terminal 201 may be reproduced through a speaker 224 that is connected to the stereo 222. The integrated hands free mobile system module 200 may also have a PC serial port connector 230.

The PC serial port connector 230 may interface the processing module 232 to a personal computer (PC) 236 or other processing device. FIG. 2B depicts the processing module 232 in more detail. The personal computer 236 may have a phone directory 238, and the processing module 232 may have a phone directory 240 (FIG. 2B).

Furthermore, the personal computer 236 may have a synchronization program 242, and the processing module 232 may have a synchronization program 244. The synchronization program 244 (FIG. 2B) in the processing module 232 is updateable with the synchronization program 242 in the personal computer 236 via the PC serial port connector 230.

The phone directory 240 in the processing module 232 is synchronizable with the phone directory 238 in the personal computer 236 via the PC serial port connector 230 using the synchronization program 244 in the processing module 232 and synchronization program 242 in the personal computer 236.

Embodiments of the present system and method may have the following features. The processing module 232 may be structured to send digits to be dialed to the mobile terminal 201 via the cable 208. The processing module may further have a voice recognition module 246 for at least converting spoken numbers into digits, and spoken words into tokens associated with a memory location in a memory 248 in the processing module 232.

The processing module 232 may be structured for at least one of: to mute the audio input device (microphone 214)(module 260), to connect the preamplifier output 234 of audio input device 214 to the voice input processor 250 of the mobile terminal 201 when a call is connected (module 261), to connect the earpiece amplifier output 256 of the mobile terminal 201 to the audio input 254 of the stereo 222 when a call is connected (module 264), to connect the preamplifier output 255 of the stereo 222 to the audio input 254 of the stereo 222 when a call is not connected or being setup (module 262), to connect the preamplifier output 234 of the audio input device 214 to the processing module 232 when a call is being setup (module 263), to store telephone numbers and associate them with spoken tokens (module 266), and to prompt a user to provide phone numbers to dial (module 267). The modules may be implemented in hardware, software, or combinations of hardware and software.

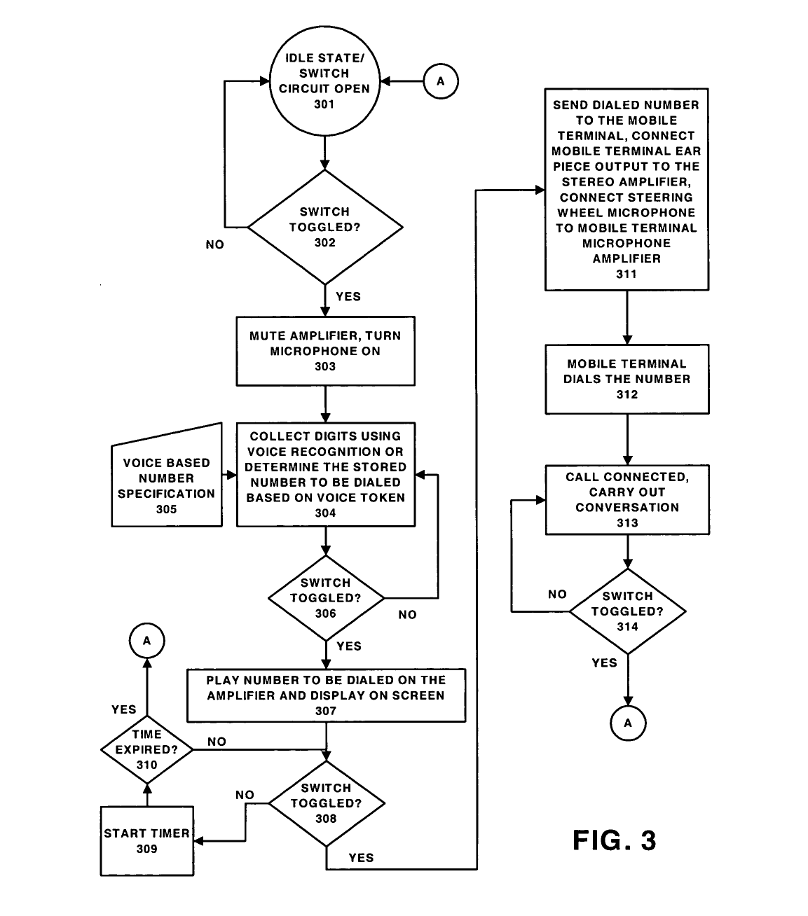

An embodiment of the method for providing hands free operation of a mobile terminal in a vehicle is depicted in FIG. 3. This embodiment may have the following steps:

(a) initially placing the system in an idle state (step 301);

(b) determining if the switch has been toggled (step 302); (c) returning to step (a) if the switch has not been toggled, and muting the amplifier and turning on the microphone if the switch has been toggled (step 303);

(d) collecting digits using voice recognition or determining the stored numbers to be dialed based on a voice token (step 304);

(e) determining if the switch has been toggled (step 306);

(f) returning to step (d) if the switch has not been toggled, and playing sounds for the numbers to be dialed via the amplifier and displaying the numbers on the display (step 307);

(g) determining if the switch has been toggled (step 308);

(h) starting, if the switch has not been toggled, a timer (309) and when a predetermined time has expired (310) returning to the idle state, and until then returning to step (g) (step 308);

(i) if the switch has been toggled, sending dialed numbers to the mobile terminal, connecting the earpiece amplifier output of the mobile terminal to the amplifier of the vehicle sound system, connecting the microphone preamplifier output of hand free mobile system to the voice input processor of the mobile terminal (step 311);

(j) dialing the number at the mobile terminal (step 312);

(k) connecting the call (step between 312 and 313);(1) maintaining call connection (step 313);

(m) determining if the switch has been toggled (step 314); and

(n) returning to step (l) if the switch has not been toggled, and returning to step (a) if the switch has been toggled (step 314).

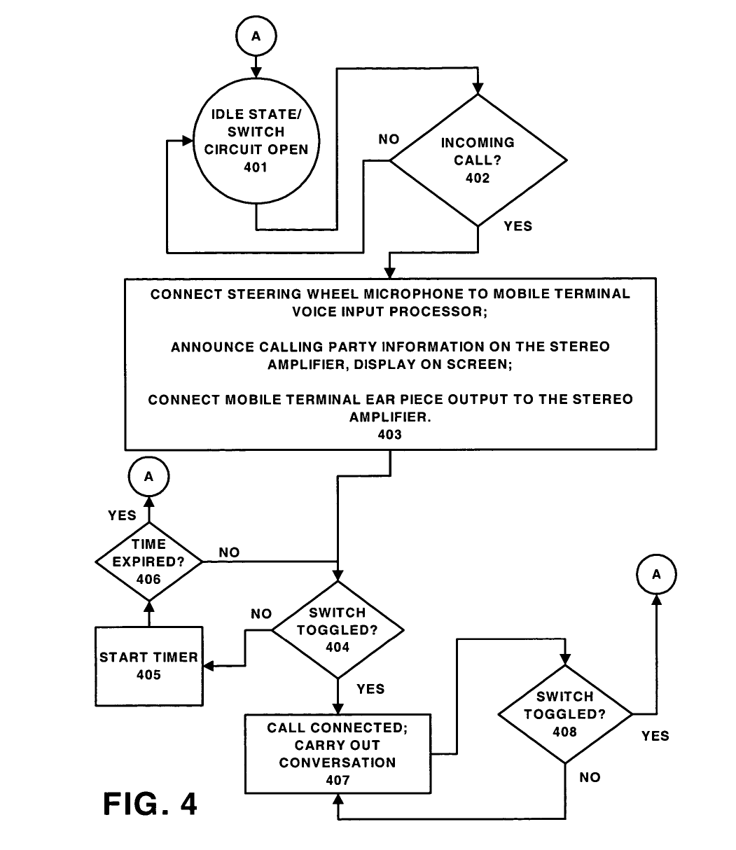

Another embodiment of the method for providing hands free operation of a mobile terminal in a vehicle is depicted in FIG. 4. This embodiment may have the following steps:

(a) initially placing the system in an idle state (step 401);

(b) determining if there is an incoming call, returning to step (a) if there is no incoming call, and proceeding to the next step if there is an incoming call (step 402);

(c) connecting the steering wheel microphone to the mobile terminal voice input processor; announcing the calling party information on the stereo amplifier, and displaying it on the screen; and connecting the mobile terminal ear piece output to the stereo amplifier (step 403);

(d) determining if the switch has been toggled (step 404);

(e) starting, if the switch has not been toggled, a timer (step 405), and if the switch has been toggled proceeding to step (g);

(f) when a predetermined time has expired (step 406) returning to the idle state, and until then returning to step (d);

(g) carrying out the conversation, the call is connected (step 407); and

(h) determining if the switch has been toggled (step 408), if the switch has not been toggled returning to step (g), and if the switch has been toggled returning to the idle state.

Thus, embodiments of the present system and method solve the problem in the prior art of providing the ability to connect any mobile handset to a built in adaptor in a vehicle or other apparatus. Embodiments of the present system and method also overcome the drawback of the prior art in that a mobile subscriber may place/receive calls, conduct conversations and terminate calls without holding any mobile terminals or attaching any headset or dialing any numbers from a keypad of the mobile terminal.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. For example, the switch may be a mechanical switch, a voice activated switch, etc. Also, the term “switch toggled” may refer, for example, to a mechanical switch toggling or state change, or a switch state change in a voice activated switch due to a set of phrases, such as “call”, “answer”, “next”, “continue”, etc. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A hands free system for operating a mobile terminal in a vehicle having a steering wheel, comprising:
a processing module detachably coupled to a mobile terminal;
an audio input device mounted substantially in a center area of the steering wheel of the vehicle, the audio input device operatively connected to the processing module;
a switch located in a predetermined area of the steering wheel, the switch operatively connected to the processing unit; and
an stereo operatively connected to the processing module.

2. The hands free system according to claim 1, wherein the audio input device is a microphone.

3. The hands free system according to claim 1, wherein the stereo comprises at least an audio amplifier operatively connected to at least one speaker.

4. The hands free system according to claim 1, wherein the processing module is detachably coupled to the mobile terminal via a cable having a universal connector that interfaces to a plurality of different mobile terminals.

5. The hands free system according to claim 1, wherein the processing module is structured to give priority to a signal from the mobile terminal over any other signal in the stereo.

6. The hands free system according to claim 1, wherein the hands free system further comprises a display operatively connected to the processing module for displaying information relative to the connected mobile terminal.

7. The hands free system according to claim 6, wherein the displayed information is downloaded information that is used by the mobile terminal.

8. The hands free system according to claim 1, wherein the switch is a toggle-type switch, and wherein each toggle of the switch is an indication to proceed to the next stage in call handling by the mobile terminal.

9. The hands free system according to claim 1, wherein the processing module is structured for at least one of: to mute the audio input device, to connect the audio input device to a voice input processor of the mobile terminal when a call is connected, to connect an earpiece amplifier output of the mobile terminal to an amplifier input of the stereo when a call is connected, to connect a preamplifier output of the stereo to the audio input of the stereo when a call is not connected or being setup, to connect the preamplifier output of the hands free mobile system to the audio input of the when the call is being setup, to store telephone numbers and associate them with spoken tokens, and to prompt a user to provide phone numbers to dial.

10. The hands free system according to claim 1, wherein the processing module further comprises a voice recognition module for at least converting spoken numbers into digits, and spoken words into tokens associated with a memory location in a memory in the processing module.

11. The hands free system according to claim 1, wherein the hands free system further comprises a PC serial port connector for interfacing the processing module to a personal computer.

12. The hands free system according to claim 11, wherein the personal computer has a phone directory, wherein the processing module has a phone directory, and wherein the phone directory in the processing module is synchronizable with the phone directory in the personal computer via the PC serial port connector.

13. The hands free system according to claim 11, wherein the personal computer has a synchronization program, wherein the processing module has a synchronization program, and wherein the synchronization program in the processing module is updateable with the synchronization program in the personal computer via the PC serial port connector.

14. The hands free system according to claim 1, wherein the processing module is structured to send digits to be dialed to the mobile terminal via the cable.

15. A hands free system for operating a mobile terminal in a vehicle having a steering wheel, comprising:
a processing module detachably coupled to a mobile terminal;
a microphone mounted substantially in a center area of the steering wheel of the vehicle, the microphone operatively connected to the processing module;
a switch located in a predetermined area of the steering wheel, the switch operatively connected to the processing unit;
a display operatively connected to the processing module for displaying information relative to the connected mobile terminal; and
a vehicle sound system operatively connected to the processing module.

16. The hands free system according to claim 15, wherein the processing module is detachably coupled to the mobile terminal via a cable having a universal connector that interfaces to a plurality of different mobile terminals.

17. The hands free system according to claim 15, wherein the processing module is structured to give priority to a signal from the mobile terminal over any other signal in vehicle sound system.

18. The hands free system according to claim 15, wherein the displayed information is downloaded information that is processed in the mobile terminal.

19. The hands free system according to claim 15, wherein the switch is a toggle-type switch, and wherein each toggle of the switch is an indication to proceed to the next stage in call handling by the processing module.

20. The hands free system according to claim 15, wherein the processing module is structured for at least one of: to mute the microphone, to connect the microphone to the voice input processor of the mobile terminal when a call is connected, to connect the earpiece amplifier output of the mobile terminal to the amplifier input of the vehicle sound system when a call is connected, to connect the preamplifier output of the stereo to the audio input of the stereo when a call is not connected or being setup, to connect the preamplifier output of the hands free mobile system to the processing module of the hands free mobile system when the call is being setup, to store telephone numbers and associate them with spoken tokens, and to prompt a user to provide phone numbers to dial.

21. The hands free system according to claim 15, wherein the processing module further comprises a voice recognition module for at least converting spoken numbers into digits, and spoken words into tokens associated with a memory location in a memory in the processing module.

22. The hands free system according to claim 15, wherein the hands free system further comprises a PC serial port connector for interfacing the processing module to a personal computer.

23. The hands free system according to claim 22, wherein the personal computer has a phone directory, wherein the processing module has a phone directory, and wherein the phone directory in the processing module is synchronizable with the phone directory in the personal computer via the PC serial port connector.

24. The hands free system according to claim 22, wherein the personal computer has a synchronization program, wherein the processing module has a synchronization program, and wherein the synchronization program in the processing module is updateable with the synchronization program in the personal computer via the PC serial port connector.

25. The hands free system according to claim 1, wherein the processing module is structured to send digits to be dialed to the mobile terminal via the cable.

26. A method for providing hands free operation of a mobile terminal in a vehicle having a steering wheel, the hands free system having: a processing module detachably coupled to a mobile terminal; a microphone mounted substantially in a center area of the steering wheel of the vehicle, the microphone operatively connected to the processing module; a switch located in a predetermined area of the steering wheel, the switch operatively connected to the processing unit; a display operatively connected to the processing module for displaying information relative to the connected mobile terminal; and a vehicle sound system operatively connected to the processing module, comprising the steps of:
(a) initially placing the system in an idle state;
(b) determining if the switch has been toggled;
(c) returning to step (a) if the switch has not been toggled, and muting the amplifier and turning on the microphone if the switch has been toggled;
(d) collecting digits using voice recognition or determining the stored numbers to be dialed based on a voice token;
(e) determining if the switch has been toggled;
(f) returning to step (d) if the switch has not been toggled, and playing sounds for the numbers to be dialed via the amplifier and displaying the numbers on the display;
(g) determining if the switch has been toggled;
(h) starting, if the switch has not been toggled, a timer and when a predetermined time has expired returning to the idle state, and until then returning to step (g);
(i) if the switch has been toggled, sending dialed numbers to the mobile terminal, connecting the earpiece amplifier output of the mobile terminal to the amplifier of the vehicle sound system, connecting the microphone preamplifier output of hand free mobile system to voice input processor of the mobile terminal;
(i) dialing the number at the mobile terminal;
(k) connecting the call;
(l) maintaining call connection;
(m) determining if the switch has been toggled;
(n) returning to step (l) if the switch has not been toggled, and returning to step (a) if the switch has been toggled.

27. A method for providing hands free operation of a mobile terminal in a vehicle having a steering wheel, the hands free system having: a processing module detachably coupled to a mobile terminal; a microphone mounted substantially in a center area of the steering wheel of the vehicle, the microphone operatively connected to the processing module; a switch located in a predetermined area of the steering wheel, the switch operatively connected to the processing unit; a display operatively connected to the processing module for displaying information relative to the connected mobile terminal; and a vehicle sound system operatively connected to the processing module, comprising the steps of:
(a) initially placing the system in an idle state;
(b) determining if there is an incoming call, returning to step (a) if there is no incoming call, and proceeding to the next step if there is an incoming call;
(c) connecting the microphone to the mobile terminal voice input processor, announcing the calling party information on the stereo amplifier, and displaying it on the screen; and connecting the mobile terminal ear piece output to the stereo amplifier;
(d) determining if the switch has been toggled;
(e) starting, if the switch has not been toggled, a timer, and if the switch has been toggled proceeding to step (g);
(f) when a predetermined time has expired (step 406) returning to the idle state, and until then returning to step (d);
(g) carrying out the conversation, the call is connected; and
(h) determining if the switch has been toggled, and if the switch has not been toggled returning to step (g), and if the switch has been toggled returning to the idle state.
